(19) United States
(12) Patent Application Publication
(10) Pub. No.: US 2008/0313366 A1
(43) Pub. Date: Dec. 18, 2008

(54) Information processing apparatus, system control device, and input/output requesting method

(75) Inventor: Shigekatsu Sagi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/222,591

(22) Filed: Aug. 12, 2008

Related U.S. Application Data
(63) Continuation of application No. PCT/JP2006/302473, filed on Feb. 13, 2006.

(51) Int. Cl. G06F 13/20

(52) U.S. Cl. 710/38

(57) ABSTRACT

A path selecting unit searches, upon receiving an enquiry of a path to an input/output device from a central processing unit, a storing unit that stores therein device identification information and path identification information by using device identification information included in the enquiry as a key, retrieves path identification information of an enquired path, and returns retrieved path identification information to the central processing unit in response to the enquiry. When one of the paths becomes unavailable, an updating unit updates the storing unit such that an unavailable path is not selected by the path selecting unit.

### BACKGROUND OF THE INVENTION

1. Field of the Invention

The present invention relates to an information processing apparatus redundant paths connecting a central processing unit (CPU) and an input/output (I/O) device, and a system control device and an I/O requesting method for the information processing apparatus, and more particularly, to an information processing apparatus, a system control device, and an I/O requesting method with a capability of realizing high reliability and usability using a simple structure at low cost.

2. Description of the Related Art

Recently, for enhancing usability and reliability, a large-scale information processing apparatus such as a server often includes a plurality of mounted central processing units (CPU) and a redundant structure of input/output (I/O) devices and various types of transportation paths.

For example, in an information processing apparatus that is called a blade server disclosed in Japanese Patent Application Laid-open No. 2005-228308, a plurality of independently operable server boards can be mounted inside a chassis and the server boards are connected to an I/O devices such as a network interface device via a backboard. A device called monitoring module monitors a connection between the server boards and the I/O device. Upon occurrence of a breakdown, the monitoring module dynamically reconnects the server boards to another I/O device and continues a process.

However, using a specific device such as the monitoring module to monitor and rectify a breakdown increases a cost of the information processing apparatus. Recently, along with developments in data processing, servers are increasingly introduced even in relatively small scale enterprises. The small scale enterprises are strongly demanding provision of a highly reliable and usable server at a low cost.

### SUMMARY

It is an object of the present invention to at least partially solve the problems in the conventional technology.

According to an aspect of the present invention, there is provided an information processing apparatus having redundant paths connecting a central processing unit and an input/output device. The information processing apparatus includes a storing unit that stores therein device identification information for identifying an input/output device and path identification information for identifying a path to the input/output device; a path selecting unit that searches, upon receiving an enquiry of a path to an input/output device from a central processing unit, the storing unit by using device identification information included in the enquiry as a key, retrieves path identification information of an enquired path, and returns retrieved path identification information to the central processing unit in response to the enquiry; and an updating unit that updates, when one of the paths becomes unavailable, the storing unit such that an unavailable path is not selected by the path selecting unit. The central processing unit performs the enquiry of a path to the input/output device before issuing an input/output command for the input/output device, and issues the input/output command for a path returned in response to the enquiry.

Furthermore, according to another aspect of the present invention, there is provided a system control device that controls input and output with respect to a main memory and an input/output device in an information processing apparatus having redundant paths connecting a central processing unit and an input/output device. The system control device includes a storing unit that stores therein device identification information for identifying an input/output device and path identification information for identifying a path to the input/output device; a path selecting unit that searches, upon receiving an enquiry of a path to an input/output device from a central processing unit, the storing unit by using device identification information included in the enquiry as a key, retrieves path identification information of an enquired path, and returns retrieved path identification information to the central processing unit in response to the enquiry; and an updating unit that updates, when one of the paths becomes unavailable, the storing unit such that an unavailable path is not selected by the path selecting unit.

Moreover, according to still another aspect of the present invention, there is provided an input/output requesting method for an information processing apparatus having redundant paths connecting a central processing unit and an input/output device. The input/output requesting method includes path enquiring including a central processing unit issuing an enquiry of a path to an input/output device; path selecting including a path selecting unit searching, upon receiving the enquiry of a path issued at the path enquiring, a storing unit that stores therein device identification information for identifying an input/output device and path identification information for identifying a path to the input/output device by using device identification information included in the enquiry as a keys retrieving path identification information of an enquired path, and returning retrieved path identification information to the central processing unit in response to the enquiry; input/output executing including the central processing unit issuing an input/output command for a path returned in response to the enquiry; and updating, when one of the paths becomes unavailable, the storing unit such that an unavailable path is not selected at the path selecting.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an example of an information processing apparatus that executes an I/O requesting method according to a first embodiment of the present invention;

FIG. 2 is a flowchart of a process sequence of the I/O requesting method according to the first embodiment;

FIG. 3 is a schematic diagram of an example of a process in the I/O requesting method according to the first embodiment;

FIG. 4 is a flowchart of a process sequence after occurrence of a breakdown;

FIG. 5 is a schematic diagram of an example of a process after occurrence of the breakdown;

FIG. 6 is a block diagram of a system control device according to the first embodiment;

FIG. 7 is a flowchart of a process sequence of an I/O requesting method according to a second embodiment of the present invention;

FIG. 8 is a schematic diagram of an example of a process in the I/O requesting method according to the second embodiment;

FIG. 9 is a block diagram of a system control device according to the second embodiment;

FIG. 10 is a flowchart of a process sequence of an I/O requesting method according to a third embodiment of the present invention;

FIG. 11 is a schematic diagram of an example of a process in the I/O requesting method according to the third embodiment;

FIG. 12 is a schematic diagram of an example of address areas for I/O devices that are allocated in a portion of an address space;

FIG. 13 is a schematic diagram of an example of a selection of an issuing destination of an I/O command using a decoder; and

FIG. 14 is a schematic diagram of an example of a selection of the issuing destination of the I/O command using a table search.

### DETAILED DESCRIPTION OF THE PREFERRED EMBODIMENTS

Exemplary embodiments of the present invention are explained in detail below with reference to the accompanying drawings. However, the present invention is not to be limited to the embodiments.

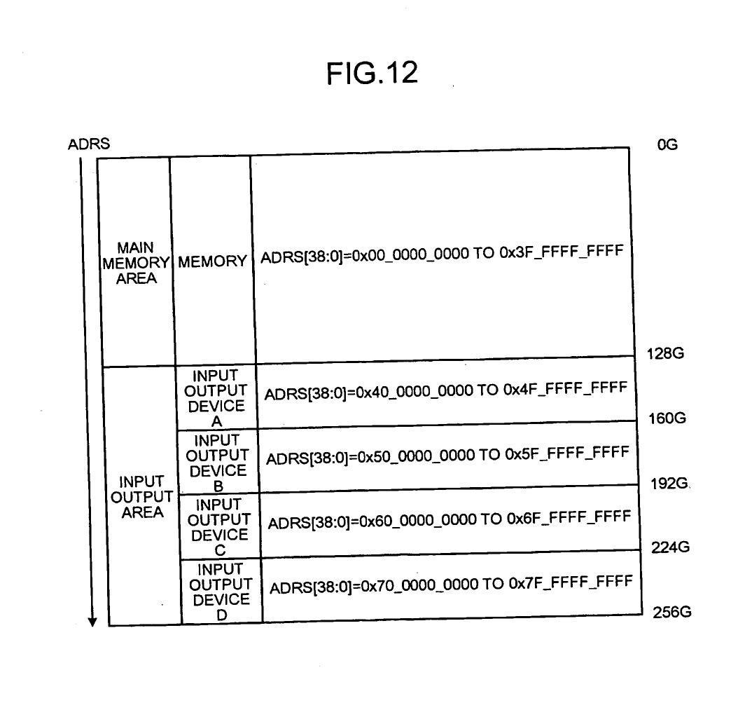

An I/O requesting method in an existing information processing apparatus is explained first. As shown in FIG. 12, in the information processing apparatus that uses a memory mapped I/O, an address area for each I/O device is allocated to a portion of an address space. An I/O process with respect to an I/O device is carried out by accessing the respective address area for the I/O device.

To be specific, upon a request issuing source accessing the address area for the I/O device, a central processing unit (CPU) interprets the address and decides a path for issuing an I/O command. A correspondence among the address area, the path, and an I/O device are prior fixed according to a device structure.

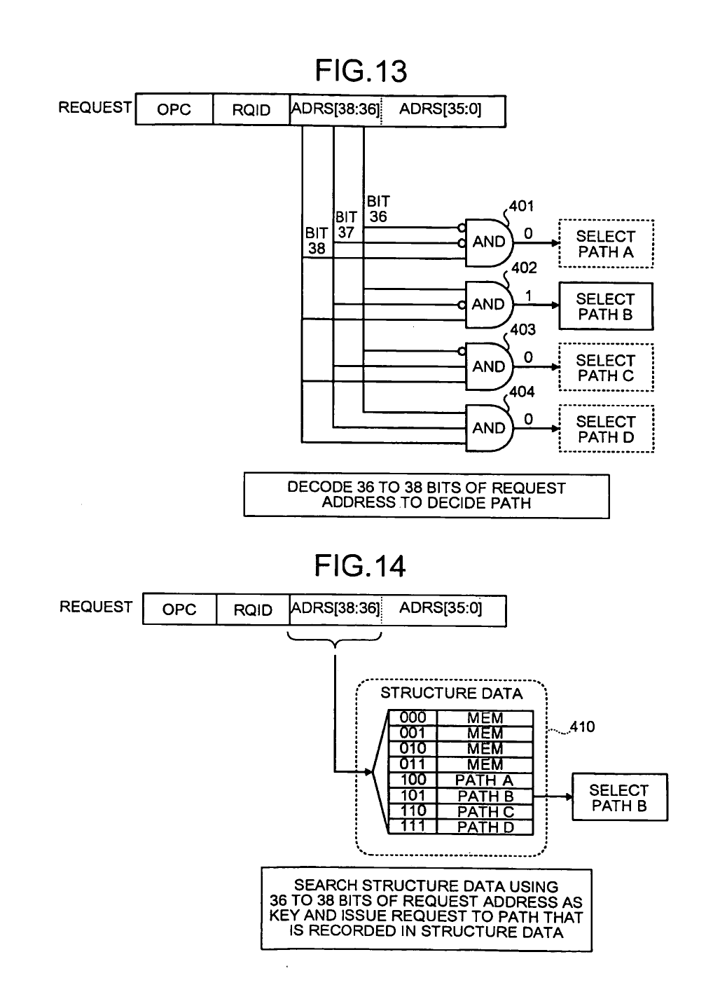

FIG. 13 is a schematic diagram of an example of a selection of an issuing destination of the I/O command using a decoder. In the example shown in FIG. 13, the issuing destination of the I/O command is selected by decoding thirty sixth to thirty eighth bits of the address that is instructed by the request issuing source. According to the example shown in FIG. 12, when read/write is carried out with respect to an I/O device B, “101” is instructed in the thirty sixth to the thirty eighth bits of the address, an AND circuit 402 in the decoder shown in FIG. 13 outputs 1, and a path B is selected as the issuing destination of the I/O command.

FIG. 14 is a schematic diagram of an example of the selection of the issuing destination of the I/O command using a table search. In the example shown in FIG. 14, the issuing destination of the I/O command is selected by searching a table (structure data 410) that stores therein a combination of a value of the thirty sixth to the thirty eighth bits of the address, instructed by the request issuing source, and the path. According to the example shown in FIG. 12, when read/write is carried out with respect to the I/O device B, “101” is instructed in the thirty sixth to the thirty eighth bits of the address, a fifth entry that includes a bit pattern of “101” is searched in the table shown in FIG. 14, and the path B that is recorded in the entry is selected as the issuing destination of the I/O command.

In any of the methods mentioned earlier, a correspondence between the address area, the path, and the I/O device is prior fixed, and the request issuing source needs to determine the address area to be accessed according to a process target I/O device. Further, if the paths between the CPU and the I/O devices are redundant, thus enabling selection of multiple paths, the request issuing source needs to determine the path to be used.

Thus, even if the I/O devices and the paths in the information processing apparatus are redundant, thus including a mechanism for dealing with a breakdown, for carrying out the I/O process by avoiding the I/O device and the path where the breakdown has occurred, the request issuing source needs to be able to modify the address area to be accessed according to circumstances. Further, for enabling the request issuing source to recognize a change in the correspondence between the address area, the path, and the input device without stopping the information processing apparatus, a specific mechanism (for example, the monitoring module disclosed in Japanese Patent Application Laid-open No. 2005-228308) is necessitated that can monitor and notify occurrence of the breakdown.

The request issuing source explained earlier corresponds to a driver software that generally operates as a portion of an operating system (OS). However, the OS itself or an application program can also function as the request issuing source.

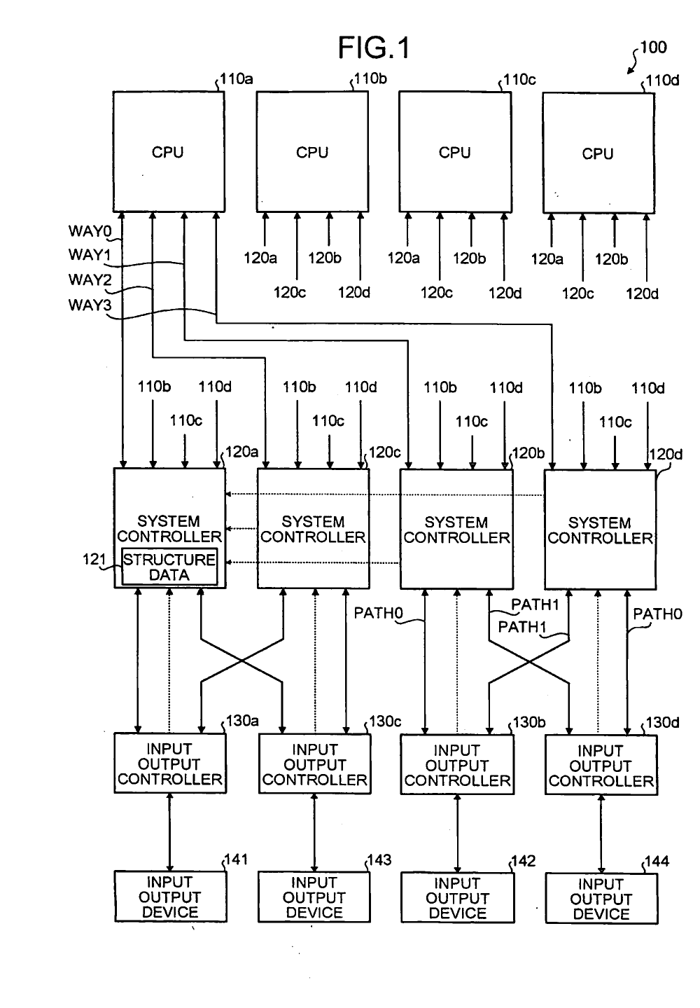

An I/O requesting method according to a first embodiment of the present invention is explained next. FIG. 1 is a schematic diagram of an example of an information processing apparatus that executes the I/O requesting method according to the first embodiment. For the sake of convenience, components such as a later explained memory access controller, which is not directly related to the I/O requesting method according to the first embodiment, are not shown in FIG. 1.

As shown in FIG. 1, an information processing apparatus 100 includes CPUs 110a to 110d, system control devices 120a to 120d, I/O controllers 130a to 130d, and I/O devices 141 to 144.

The CPUs 110a to 110d are calculating devices that execute various processes for operating the OS and the application programs. The system control devices 120a to 120d control input/output to a main memory and the I/O devices 141 to 144. Each CPU is connected to the system control devices 120a to 120d via four paths WAY0 to WAY3 respectively. To be specific, each CPU is connected to the system control device 120a via the path WAY0, connected to the system control device 120b via the path WAY1, connected to the system control device 120c via the path WAY2, and connected to the system control device 120d via the path WAY3.

The I/O controllers 130a to 130d control the input/output to the I/O devices 141 to 144. Each I/O controller is connected to two system control devices via two paths. For example, the I/O controller 130b is connected to the system control device 120b via PATH0 and connected to the system control device 120d via PATH1.

The I/O devices 141 to 144 are I/O devices for a network interface device or a memory device. The I/O devices 141 to 144 are connected to the I/O controllers 130a to 130d respectively.

In the example shown in FIG. 1, because a connection between the system control devices 120a to 120d and the I/O controllers 130a to 130d include a redundant structure, two paths are formed between the CPUs 110a to 110d and the I/O devices 141 to 144. For example, the CPU 110a and the I/O device 142 are connected by a path that progresses from the CPU 110a to the system control device 120b, the I/O controller 130b, and the I/O device 142. Further, the CPU 110a and the I/O device 142 are also connected by another path that progresses from the CPU 110a to the system control device 120d, the I/O controller 130b, and the I/O device 142. When using the former path, the CPU 110a needs to issue the I/O command to the path WAY1. When using the latter path, the CPU 110a needs to issue the I/O command to the path WAY3.

One of the system control devices 120a to 120d decides to carry out the I/O process using any one of the redundant paths. In the example shown in FIG. 1, the system control device 120a decides the path. For deciding the path, the system control device 120a stores therein structure data 121. The structure data 121 defines a correspondence between the address area that is allocated to the I/O device and a destination path of a command.

Further, for notifying the breakdown of an I/O device and the path to the system control device 120a, wiring is included between each I/O controller and each system control device. Similarly, wiring is also included between the system control devices 120b to 120d and the system control device 120a. Upon being notified of occurrence of the breakdown in the path via the wiring, the system control device 120a resets the structure data 121 such that the other redundant path is used.

All the paths can be prior recorded inside the system control device 120a and the system control device 120a can select the path among the recorded paths as a method to retrieve a substitute path. Alternatively, upon occurrence of the breakdown, the system control device 120a can also enquire about the substitute path to the other system control devices.

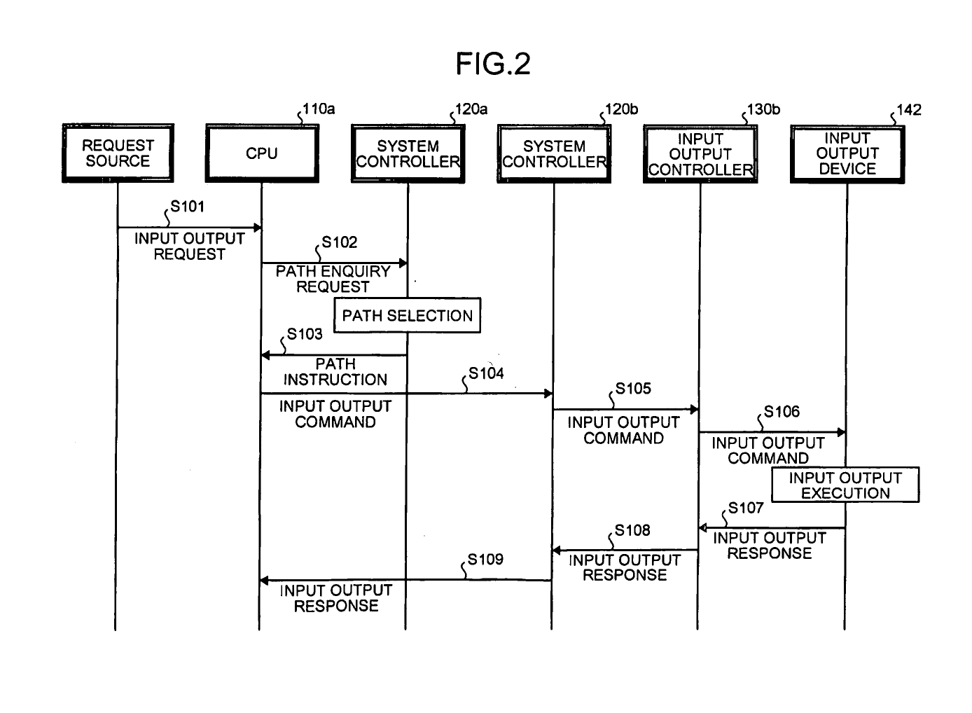

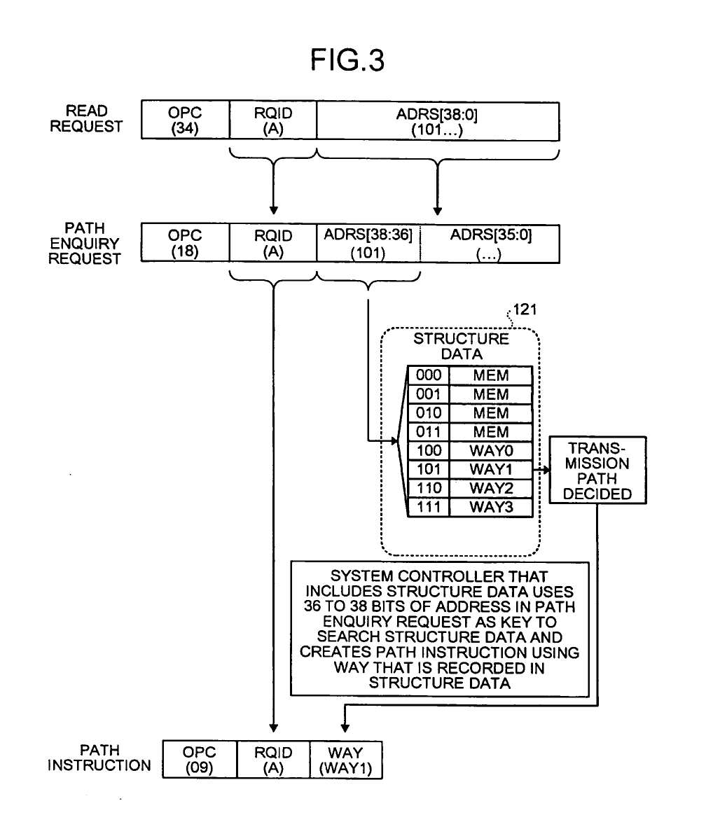

A process flow of the I/O requesting method according to the first embodiment is explained with reference to FIGS. 2 and 3. It is assumed that the request issuing source issues to the CPU 110a, a read request (operation code 34) of data with respect to the I/O device 142 (step S101). Upon receiving the read request, the CPU 11a issues a path enquiry request (operation code 18) to the system control device 120a (step S102). The CPU 110a sets, as values of a request identification (RQID) for identifying a request and an address (ADDR) for identifying the I/O device, the same values that are distributed by the request issuing source.

Upon receiving the path enquiry request, the system control device 120a searches the structure data 121 by using the value of the thirty sixth to the thirty eighth bits of the address as a key and responds to the CPU 110a by including the obtained path into an argument of a path instruction (operation code 09) (step S103). When responding to the CPU 110a, the system control device 120a sets in the RQID, the same value that is instructed in the path enquiry request. In the example shown in FIG. 3, the value of the thirty sixth to the thirty eighth bits of the address is “101” and upon searching the structure data 121 by using the value as the key, the path WAY1 is decided as the destination.

Upon receiving the response of the path instruction, the CPU 11a issues a read data command towards the path WAY1 (step S104). When issuing the read data command, the CPU 110a sets the same values for the RQID and the address that are distributed from the request issuing source.

Based on the address, the read data command is transmitted via the path that progresses to the system control device 120b, the I/O controller 130b, and the I/O device 142 (steps S105 and S106). Next, the I/O device 142 responds by reading the instructed data. The response follows the path in the reverse direction and is returned to the CPU 110a (steps S107 to S109).

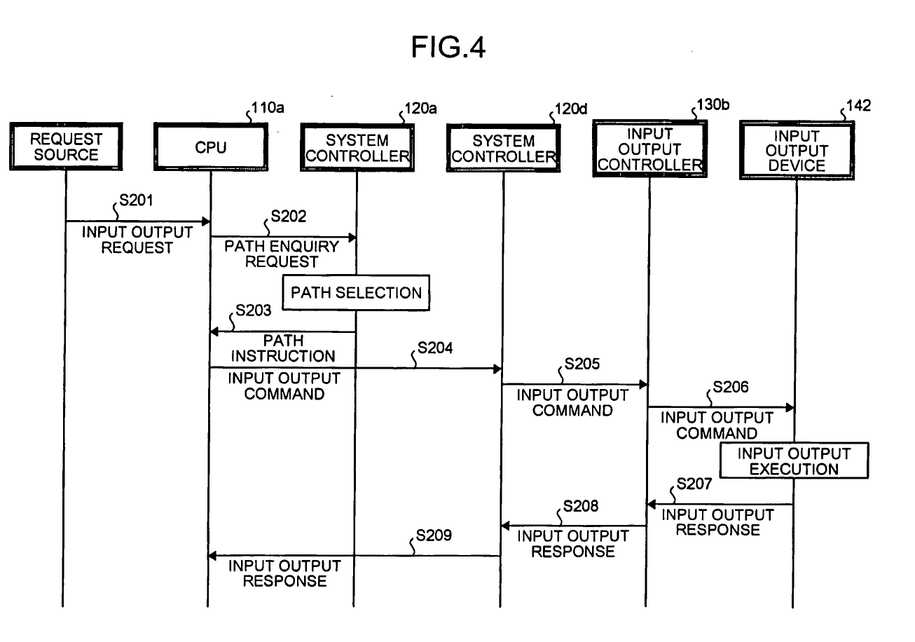

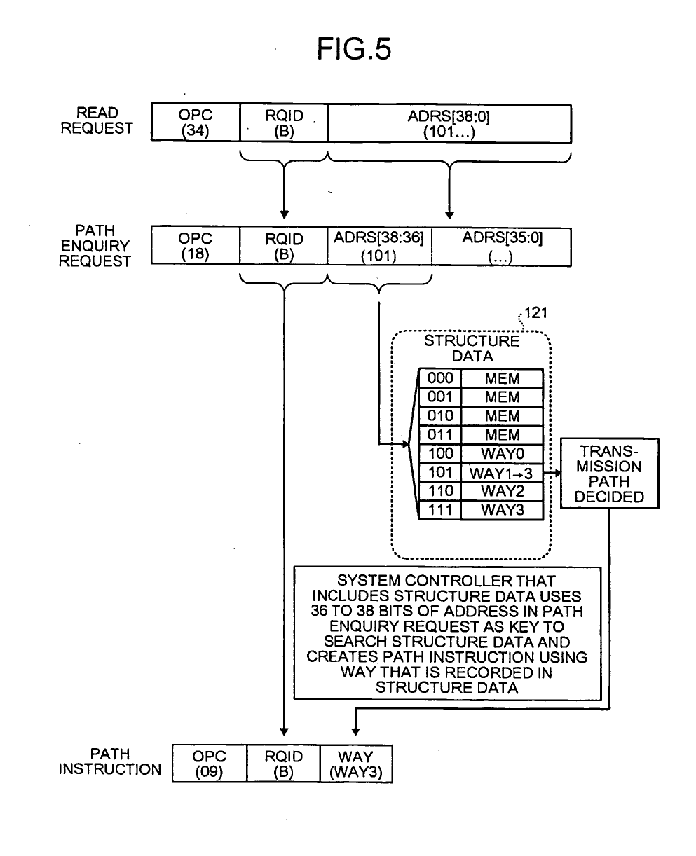

Next, a process flow when the breakdown occurs in the path between the system control device 120b and the I/O controller 130b is explained with reference to FIGS. 4 and 5. Upon occurrence of the breakdown in the path between the system control device 120b and the I/O controller 130b, the system control device 120b notifies the system control device 120a that the breakdown has occurred and modifies an entry with respect to the I/O device 142 such that the path WAY3 becomes the destination.

Under the condition mentioned earlier, it is assumed that the request issuing source issues to the CPU 110a, the read request (operation code 34) of the same data that is shown in FIG. 3 (step S201). Because the read request is a different request, the value of the RQID is different. However, the values of the other entries are the same as the values shown in FIG. 3.

Upon receiving the read request, the CPU 110a issues the path enquiry request (operation code 18) to the system control device 120a (step S202). When issuing the path enquiry request, the CPU 110a sets the same values, which are distributed from the request issuing source, of the request ID (RQID) for identifying the request and of the address (ADDR) for identifying the I/O device.

Upon receiving the path enquiry request, the system control device 120a searches the structure data 121 by using the value of the thirty sixth to the thirty eighth bits of the address as the key and responds to the CPU 110a by including the obtained path into the argument of the path instruction (operation code 09) (step S203). When responding to the CPU 110a, the system control device 120a sets in the RQID, the same value that is instructed in the path enquiry request. In the example shown in FIG. 5, the value of the thirty sixth to the thirty eighth bits of the address is “101” and upon searching the structure data 121 by using the value as the key, the path WAY3 is decided as the destination.

Upon receiving the response of the path instruction, the CPU 110a issues the read data command towards the path WAY3 (step S204). When issuing the read data command, the CPU 110a sets the same values for the RQID and the address as the respective values that are distributed from the request issuing source.

Based on the address, the read data command is transmitted via the path that progresses to the system control device 120d, the I/O controller 130b, and the I/O device 142 (steps S205 and S206). Next, the I/O device 142 responds by reading the instructed data. The response follows the path in the reverse direction and is returned to the CPU 110a (steps S207 to S209).

In the process flow mentioned earlier, the request issuing source issues the read request of a content that is similar to the content shown in FIG. 3. However, based on a result of the path enquiry, because the system control device 120a responds using a normal path, the I/O process can be carried out by avoiding the path where the breakdown has occurred.

Thus, a mechanism is included which notifies the breakdown in the path to one of the system control devices and the system control device grasps the normal path to each I/O device. When issuing the I/O command to the I/O device, the CPU enquires the path to the system control device. Due to this, even if the breakdown occurs in a portion of the redundant paths, the process can be continued by using the other path.

In the method mentioned earlier, enhancement of reliability of the information processing apparatus can be realized at a low cost by adding a simple mechanism to the existing device without adding a specific device such as the monitoring module. Further, even if a breakdown occurs in the path, because the request issuing source does not need to be aware of the breakdown, the existing OS can be used.

A function, which maintains the structure data 121, receives the path enquiry from the CPU to the I/O device, and responds to the path enquiry, need not always be realized by the system control device. The function can also be realized by other devices. However, for realizing the function at a low cost, the function is desirably added to an existing device that includes a high speed connection to the CPU.

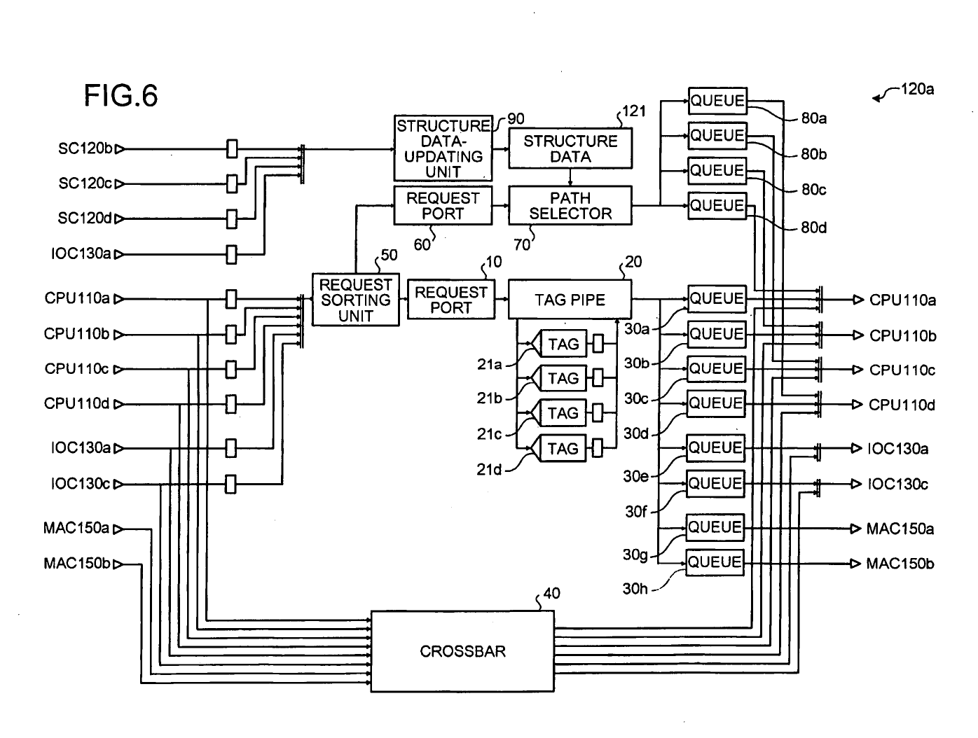

A structure of the system control device 120a is explained next. FIG. 6 is a block diagram of the system control device 120a. As shown in FIG. 6, the system control device 120a includes a request port 10, a tag pipe 20, tags 21a to 21d, queues 30a to 30h, a crossbar 40, a request sorting unit 50, a request port 60, a path selector 70, queues 80a to 80d, a structure data-updating unit 90, and the structure data 121.

Among the components mentioned earlier, the request port 10, the tag pipe 20, the tags 21a to 21d, the queues 30a to 30h, and the crossbar 40 are generally included in the existing system control devices such as the system control devices 120b to 120d. The request sorting unit 50, the request port 60, the path selector 70, the queues 80a to 80d, the structure data-updating unit 90, and the structure data 121 are specifically included in the system control device 120a.

The request port 10 temporarily stores therein the I/O requests that are received from the CPUs 110a to 110d, the I/O controllers 130a and 130c, and inserts the I/O requests into the tag pipe 20 according to a priority sequence. The tag pipe 20 searches the tags 21a to 21d, decides, mainly based on coherence, a process destination of the I/O requests, and issues the I/O requests to the process destination.

The tags 21a to 21d correspond to the CPUs 110a to 110d respectively. The tags 21a to 21d store therein a copy of tag data of data that is cached by the corresponding CPU. The tags 21a to 21d are mainly used for maintaining coherence of data. Because a method in which the tag pipe 20 uses the tags 21a to 21d to decide the process destination is already known, an explanation is omitted.

The queues 30a to 30h correspond respectively to the CPUs 110a to 110d, the I/O controllers 130a and 130c, and memory access controllers 150a and 150b. The queues 30a to 30h store therein in an ordered sequence, the requests that the tag pipe 20 has issued with respect to the corresponding device, and transmit the requests when the requests have become processable.

The crossbar 40 routs the response with respect to the request and transmits the response to the appropriate destination.

The request sorting unit 50 determines whether the requests that are received from the CPUs 110a to 110d and the I/O controllers 130a and 130c are the I/O requests or the path enquiry requests. If the requests are the I/O requests, the request sorting unit 50 transfers the requests to the request port 10. If the requests are the path enquiry requests, the request sorting unit 50 transfers the requests to the request port 60.

The request port 60 temporarily stores therein the path enquiry requests that are received from the CPUs 110a to 110d and inserts the path enquiry requests into the path selector 70 according to the priority sequence. The path selector 70 searches the structure data 121, selects a normal path corresponding to the address that is instructed in the respective path enquiry request, and generates the path instruction.

The queues 80a to 80d correspond respectively to the CPUs 110a to 110d. The queues 80a to 80d store therein, in a generation sequence, the path instructions that are generated by the path selector 70 with respect to the corresponding CPU, and transmit the path instructions to the corresponding CPU when the path instructions have become transmittable.

The structure data-updating unit 90 receives from the system control devices 120b to 120d and the I/O controller 130a, a notification of a breakdown in a path, and updates the structure data 121 such that the path where the breakdown has occurred is not used. The structure data 121 stores therein a correspondence between the address space that is allocated to the I/O device and the path between the I/O device and the CPU. The structure data 121 stores therein a single path or multiple paths corresponding to a single I/O device.

Thus, compared to the existing structure, a device for realizing the I/O requesting method according to the first embodiment is added to the system control device 120a.

In the first embodiment, a correspondence of a normal path between the I/O device and the CPU is stored in the structure data 121 inside the system control device 120a. When carrying out the I/O process, the CPU enquires the path to the system control device 120a. Thus, a highly reliable and usable information processing apparatus can be realized using a simple structure and at a low cost.

The information processing apparatus, which includes the redundant paths between the I/O devices and the CPU, is explained in the first embodiment. However, the present invention can also be effectively applied to an information processing apparatus that includes a plurality of similar types of I/O devices that are redundant. To be specific, upon receiving the notification that a breakdown has occurred in one of the I/O devices, the system control device 120a continues the process by modifying the structure data 121 such that a path to the other redundant I/O device becomes valid.

Further, the information processing apparatus, which uses the memory mapped I/O, is explained in the first embodiment. However, the present invention can also be effectively applied to an information processing apparatus that uses I/O port-input/output. Further, a data structure of the structure data 121 need not be the same as the data structure that is shown in FIG. 3. Any data structure can be used that enables to grasp the correspondence between the I/O devices and the paths and whether a breakdown has occurred in each path.

Recently, in a technology that is widely used, the information processing apparatus is virtualized and split into partitions, and multiple operating systems are simultaneously run on a single information processing apparatus. When using the technology mentioned earlier, an independent address space is allocated to each partition. Due to this, the address area that is allocated to an I/O device in a partition is likely to be allocated to another I/O device in another partition.

If the information processing apparatus is virtualized and split into partitions, the system control devices cannot determine the paths by using the addresses that are instructed from the request issuing source. An I/O requesting method, which is used in the information processing apparatus that is virtualized and split into partitions, is explained in a second embodiment of the present invention.

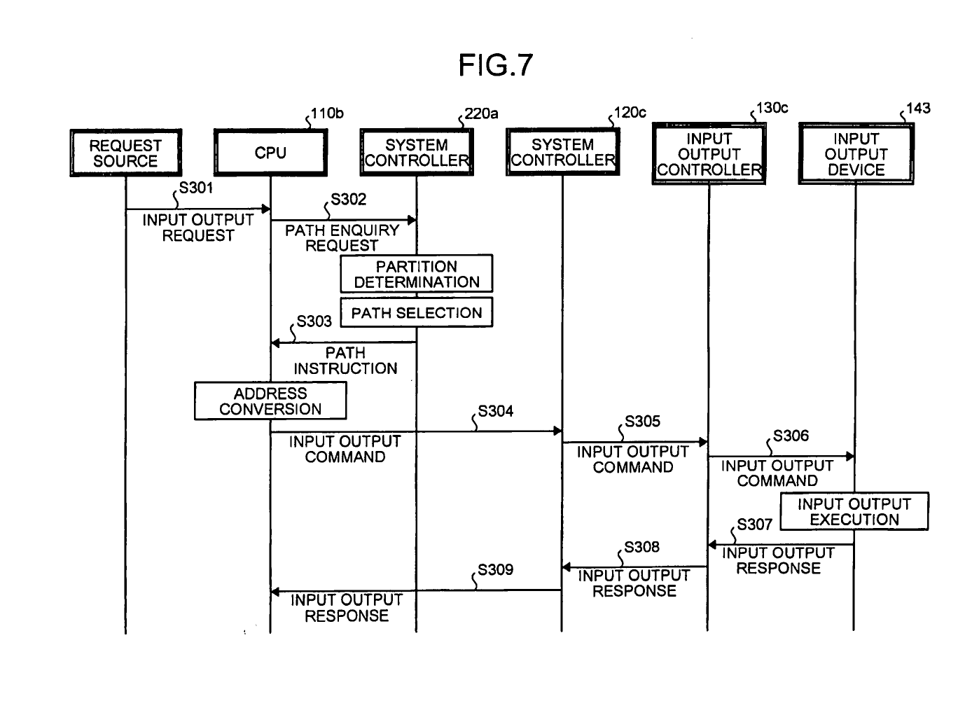

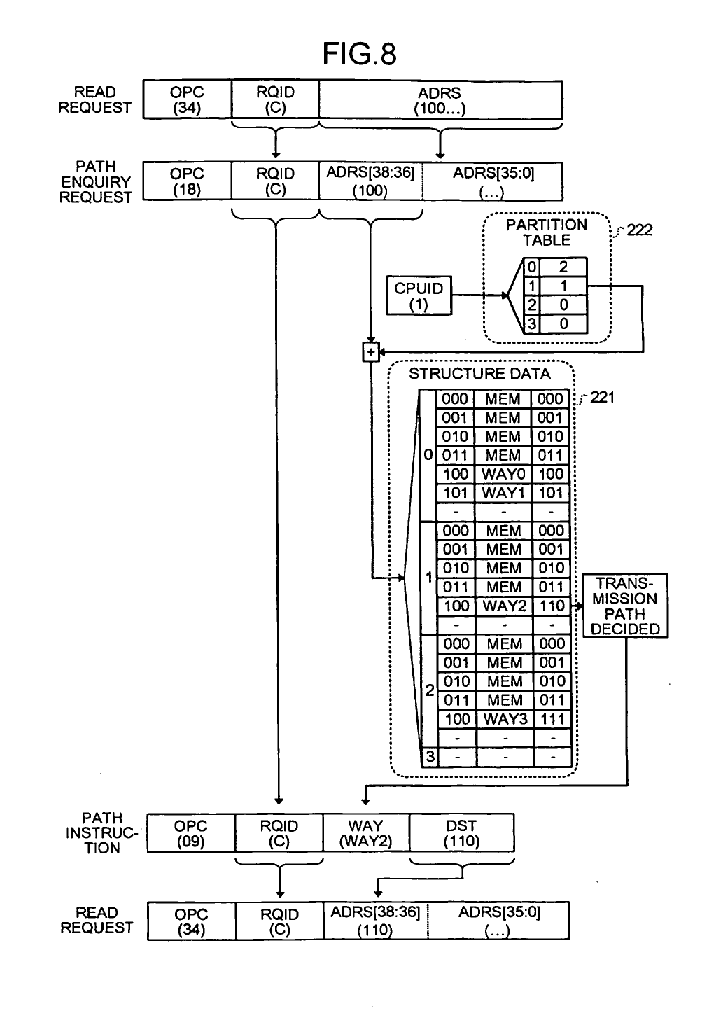

A process flow of the I/O requesting method according to the second embodiment is explained with reference to FIGS. 7 and 8. Apart from a system control device 220a, which is substituted instead of the system control device 120a, the information processing apparatus that is used for explaining the I/O requesting method includes a similar basic structure as the structure that is shown in FIG. 1.

Further, in the information processing apparatus, the CPU 110a and the I/O controllers 130a and 130b form a partition of an ID “2”. The CPU 110b and the I/O controller 130c form a partition of an ID “1”. The CPUs 110c and 110d and the I/O controller 130d form a partition of an ID “0”. Further, each system control device is shared by all the partitions.

It is assumed that in the partition of the ID “1”, the request issuing source issues to the CPU 110b, a read request (operation code 34) of data with respect to the I/O device 143 (step S301). Upon receiving the read request, the CPU 110b issues the path enquiry request (operation code 18) to the system control device 220a (step S302). When issuing the path enquiry request, The CPU 110b sets, as values of the RQID for identifying the request and the address for identifying the I/O device, the same values that are distributed by the request issuing source.

Upon receiving the path enquiry request, the system control device 220a checks the ID of the request source CPU with a partition table 222 that is stored by the system control device 220a itself and determines the affiliated partition of the request source CPU. The partition table 222 stores therein a correspondence between the ID of the CPU and the ID of the partitions. In the example shown in FIG. 8, the system control device 220a searches the partition table 222 by using the ID “1” of the request source CPU as the key to obtain the partition of the ID “1”.

Upon determining the partition, the system control device 220a refers to structure data 221 and determines the path. The structure data 221 contains for each partition, a correspondence between the address area that is allocated to the I/O device and the path between the CPU and the I/O device. Due to this, even if the same address area is allocated to different input devices in different partitions, the path can be accurately selected.

Further, in addition to data of the path between the CPU and the I/O device, each entry of the structure data 221 also stores therein data for converting into an actual address, a virtual address that is allocated to the input device in each partition. In the example shown in FIG. 8, the system control device 220a uses the thirty sixth to the thirty eighth bits of the address to determine the input device to which the address area is allocated. The data, which is used for converting the earlier mentioned portion of the address into the actual address, is stored in each entry.

The system control device 220a uses the ID of the partition and the value of the thirty sixth to the thirty eighth bits of the address as the key to search the structure data 221 and responds to the CPU 110b by including the obtained path in the argument of the path instruction (operation code 09) (step S303). When responding to the CPU 110b, the system control device 220a sets in the RQID, the same value that is instructed in the path enquiry request. In the example shown in FIG. 8, the value of the thirty sixth to the thirty eighth bits of the address is “100” and upon searching the structure data 221 by using the value and the ID “1” of the partition as the key, the path WAY2 is decided as the destination and “110” is retrieved as the data for converting the address into the actual address. The data mentioned earlier are included in the argument of the operation code of the path instruction.

Upon receiving the path instruction, the CPU 110b issues the read data command towards the path WAY2 (step S304). When issuing the read data command, the value of the thirty sixth to the thirty eighth bits of the address is substituted by the value that is included in the path instruction. In the example shown in FIG. 8, the value of the thirty sixth to the thirty eighth bits of the address is substituted from “100” to “110”. The CPU 101b sets as values for the RQID and the address, the same values that are distributed from the request issuing source.

Based on the address, the read data command is transmitted via the path that progresses to the system control device 120c, the I/O controller 130c, and the I/O device 143 (steps S305 and S306). Next, the I/O device 143 responds by reading the instructed data. The response follows the path in the reverse direction and is returned to the CPU 110b (steps S307 to S309).

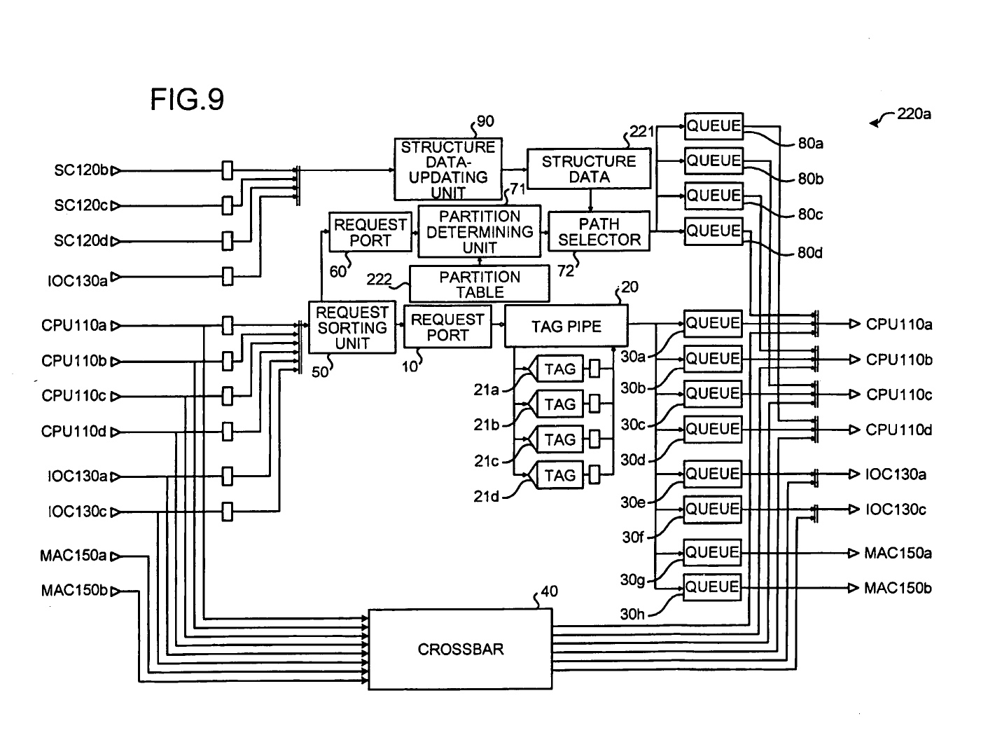

A structure of the system control device 220a is explained next. FIG. 9 is a block diagram of the system control device 220a. In the structure of the system control device 220a, only the portions that differ from the system control device 120a shown in FIG. 6 are explained.

The request port 60 inserts the path enquiry requests, which are received from the CPUs 110a to 110d, into a partition-determining unit 71 instead of inserting the path enquiry requests into the path selector 70. The partition-determining unit 71 retrieves from the partition table 222, identification data of the partition to which a transmission source CPU of the path enquiry request is affiliated. The partition-determining unit 71 adds the identification data to the path enquiry request and transfers the path enquiry request to a path selector 72.

The path selector 72 searches the structure data 221, selects a normal path corresponding to the address that is instructed in the path enquiry request and the partition that is determined by the partition-determining unit 71, and generates the path instruction. The path selector 72 retrieves from the structure data 221, the data for substituting to the actual address, the address that is instructed in the path enquiry request.

Thus, in the second embodiment, a mechanism is added that determines the partition to which the CPU is affiliated, and a determination result is used to select the path. Due to this, even in the information processing apparatus that is virtually split into the partitions, high reliability and usability can be realized at a low cost.

Further, during a transaction between the CPU and the system control device 220a, the virtual address corresponding to the I/O device is converted into the actual address. Due to this, the OS does not need to be aware of the virtual splitting of the information processing apparatus, and software can be flexibly configured.

Applying the technology explained in the embodiments mentioned earlier also enables to realize load sharing. Realizing the load sharing by applying the I/O requesting method explained in the first embodiment is explained in a third embodiment of the present invention.

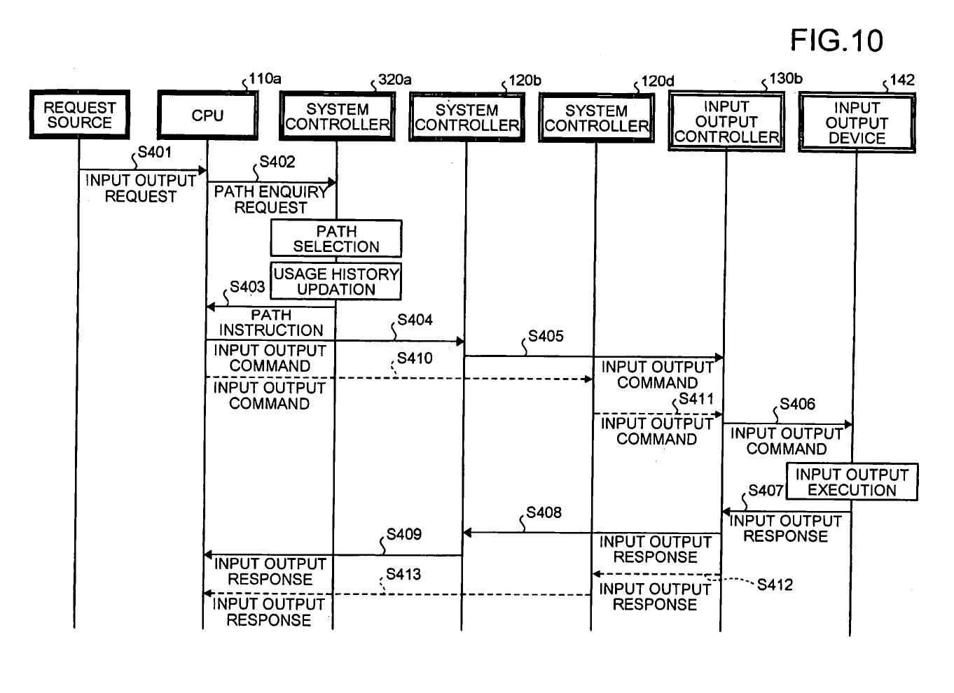

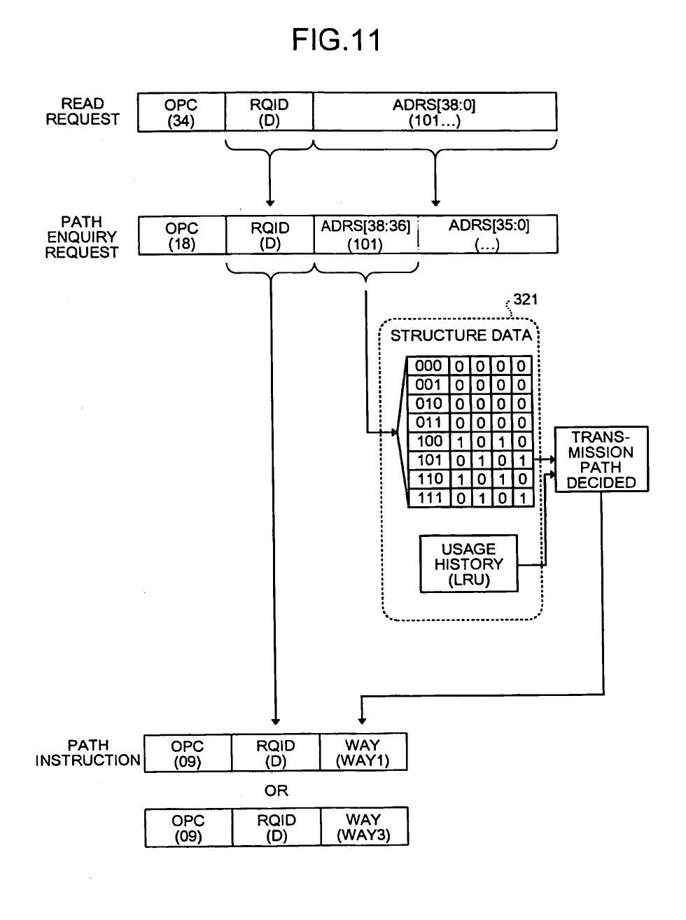

A process flow of the I/O requesting method according to the third embodiment is explained with reference to FIGS. 10 and 11. Apart from a system control device 320a, which is substituted instead of the system control device 120a, the information processing apparatus that is used for explaining the I/O requesting method includes a similar basic structure as the structure that is shown in FIG. 1.

It is assumed that the request issuing source issues to the CPU 110a, the read request (operation code 34) of data with respect to the I/O device 142 (step 5401). Upon receiving the read request, the CPU 110a issues the path enquiry request (operation code 18) to the system control device 320a (step S402). When issuing the read data request, the CPU 110a sets, in the RQID for identifying the request and in the address for identifying the I/O device, the same values that are distributed from the request issuing source.

Upon receiving the path enquiry request, the system control device 320a uses the value of the thirty sixth to the thirty eighth bits of the address as the key, searches structure data 321 and responds to the CPU 110a by including the obtained path into the argument of the path instruction (operation code 09) (step S403). When responding to the CPU 110a, the system control device 320a sets in the RQID, the same value that is instructed in the path enquiry request.

The structure data 321 establishes and stores therein a correspondence between the value of the thirty sixth to the thirty eighth bits of the address and validity of each path to the I/O device corresponding to the address area.

In the example shown in FIG. 11, the structure data 321 establishes and stores therein a correspondence between the value “101” of the thirty sixth to the thirty eighth bits of the address and four values of “0”, “1”, “0”, and “1”. The values “0”, “1”, “0”, and “1” respectively indicate whether the paths WAY0, WAY1, WAY2, and WAY3 are valid as paths to the I/O device that corresponds to the address area “100”. “1” indicates that the path is valid. “0” indicates that the path is either not connected from the beginning or cannot be used due to a breakdown.

The system control device 320a uses the value of the thirty sixth to the thirty eighth bits of the address as the key to search the structure data 321. Upon grasping that multiple paths are usable, the system control device 320a refers to a usage history (least recently used (LRU)) and selects a path that is least recently used. Due to this, each redundant path is used in turn and the load sharing is realized. For maintaining the latest usage history, the system control device 320a updates the usage history after selecting the path.

A method that uses the usage history need not always be used as the method to decide the path that is selected when multiple paths are usable. For example, each path can be used in turn by using a counter, a random number, or a queue.

In the example shown in FIG. 11, upon searching the structure data 321 by using the value of the thirty sixth to the thirty eighth bits of the address as the key, the paths WAY1 and WAY3 are found to be usable as paths.

After referring to the usage history, if the path WAY1 is selected as the path, upon receiving the path instruction, the CPU 110a issues the read data command towards the path WAY1 (step S404). When issuing the read data command, the CPU 110a sets the same values for the RQID and the address that are distributed from the request issuing source.

Based on the address, the read data command is transmitted via the path that progresses to the system control device 120b, the I/O controller 130b, and the I/O device 142 (steps S405 and S406). Next, the I/O device 142 responds by reading the instructed data. The response follows the path in the reverse direction and is returned to the CPU 110a (steps S407 to S409).

After referring to the usage history, if the path WAY3 is selected as the path, upon receiving the path instruction, the CPU 110a issues the read data command towards the path WAY3 (step S410). When issuing the read data command, the CPU 110a sets the same values for the RQID and the address that are distributed from the request issuing source.

Based on the address, the read data command is transmitted via the path that progresses to the system control device 120d, the I/O controller 130b, and the I/O device 142 (steps S411 and S406). Next, the I/O device 142 responds by reading the instructed data. The response follows the path in the reverse direction and is returned to the CPU 110a (steps S407, S412, and S413).

Although a process logic of the system control device 320a for path selection is modified, because a structure of the system control device 320a is similar to the structure of the system control device 120a that is shown in FIG. 6, an explanation of the structure is omitted.

In the third embodiment, the usage history is used such that the redundant paths are used in turn. Thus, load sharing can be realized.

As described above, according to an aspect of the present invention, a correspondence between I/O devices and paths that are connected to the I/O devices is stored as data in a storage unit and a content of the data is updated according to occurrence of a breakdown in a path. Upon receiving an enquiry from a CPU, a path selector searches the data stored in the storage unit and selects a path for issuing an I/O command. Due to this, if a breakdown occurs in a path for input/output, switching to another normal path can be automatically carried out. Thus, high reliability and usability can be realized.

Furthermore, according to another aspect of the present invention, the path selector is realized in a system control device. Thus, high reliability and usability can be realized at a low cost without the necessity to include a specific wiring between the CPU and the I/O controller.

Moreover, according to still another aspect of the present invention, the storage unit and the path selector are included that can identify each virtualized information processing apparatus. Due to this, high reliability and usability can be realized even in the information processing apparatus that can split itself into virtual information processing apparatuses.

Furthermore, according to still another aspect of the present invention, based on a result of a transaction between the CPU and the path selector, virtual identification data, which is used for identifying the I/O devices in the virtual information processing apparatus, is substituted by physical identification data that is used for identifying the I/O devices in the physical information processing apparatus. Due to this, an operating system, which operates on the virtual information processing apparatus, does not need to be aware of an operation environment.

Moreover, according to still another aspect of the present invention, whenever receiving a path enquiry from the CPU, the path selector selects in turn, a single path from a plurality of paths and responds to the CPU. Due to this, I/O paths are shared and load sharing can be realized.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus having redundant paths connecting a central processing unit and an input/output device, the information processing apparatus comprising:
a storing unit that stores therein device identification information for identifying an input/output device and path identification information for identifying a path to the input/output device;
a path selecting unit that searches, upon receiving an enquiry of a path to an input/output device from a central processing unit, the storing unit by using device identification information included in the enquiry as a key, retrieves path identification information of an enquired path, and returns retrieved path identification information to the central processing unit in response to the enquiry; and
an updating unit that updates, when one of the paths becomes unavailable, the storing unit such that an unavailable path is not selected by the path selecting unit, wherein
the central processing unit performs the enquiry of a path to the input/output device before issuing an input/output command for the input/output device, and issues the input/output command for a path returned in response to the enquiry.

2. The information processing apparatus according to claim 1, wherein the path selecting unit is a system control device that controls input and output with respect to the input/output device.

3. The information processing apparatus according to claim 1, wherein
the information processing apparatus has a function of virtually partitioning the information processing apparatus into a plurality of virtual information processing apparatuses and running an operating system for each of the virtual information processing apparatuses,
the storing unit further stores therein apparatus identification information for identifying a virtual information processing apparatus, the device identification information and the path identification information in the virtual information processing apparatus, and
upon receiving an enquiry of a path to an input/output device from a central processing unit, the path selecting unit identifies a virtual information processing apparatus to which the central processing unit belongs, searches the storing unit by using apparatus identification information of an identified virtual information processing apparatus and the device identification information included in the enquiry as a key, retrieves path identification information of an enquired path, and returns retrieved path identification information to the central processing unit in response to the enquiry.

4. The information processing apparatus according to claim 3, wherein
the device identification information includes virtual device identification information that is used in the virtual information processing apparatuses and physical device identification information that is used in the information processing apparatus as,
upon receiving an enquiry of a path to an input/output device from a central processing unit, the path selecting unit identifies a virtual information processing apparatus to which the central processing unit belongs, searches the storing unit by using apparatus identification information of an identified virtual information processing apparatus and virtual device identification information included in the enquiry as a key, retrieves path identification information of an enquired path and corresponding physical device identification information, and returns retrieved path identification information and physical device identification information to the central processing unit in response to the enquiry, and P1 the central processing unit uses the physical device identification information returned in response to the response as the device identification information.

5. The information processing apparatus according to claim 1, wherein when plural paths are retrieved from a search of the storing unit, the path selecting unit selects one of the paths in turn and returns a selected path to the central processing unit in response to the enquiry.

6. A system control device that controls input and output with respect to a main memory and an input/output device in an information processing apparatus having redundant paths connecting a central processing unit and an input/output device, the system control device comprising:
a storing unit that stores therein device identification information for identifying an input/output device and path identification information for identifying a path to the input/output device;
a path selecting unit that searches, upon receiving an enquiry of a path to an input/output device from a central processing unit, the storing unit by using device identification information included in the enquiry as a key, retrieves path identification information of an enquired path, and returns retrieved path identification information to the central processing unit in response to the enquiry; and
an updating unit that updates, when one of the paths becomes unavailable, the storing unit such that an unavailable path is not selected by the path selecting unit.

7. The system control device according to claim 6, wherein
the information processing apparatus has a function of virtually partitioning the information processing apparatus into a plurality of virtual information processing apparatuses and running an operating system for each of the virtual information processing apparatuses,
the storing unit further stores therein apparatus identification information for identifying a virtual information processing apparatus, the device identification information and the path identification information in the virtual information processing apparatus, and
upon receiving an enquiry of a path to an input/output device from a central processing unit, the path selecting unit identifies a virtual information processing apparatus to which the central processing unit belongs, searches the storing unit by using apparatus identification information of an identified virtual information processing apparatus and the device identification information included in the enquiry as a key, retrieves path identification information of an enquired path, and returns retrieved path identification information to the central processing unit in response to the enquiry.

8. The system control device according to claim 7, wherein
the device identification information includes virtual device identification information that is used in the virtual information processing apparatuses and physical device identification information that is used in the information processing apparatus as,
upon receiving an enquiry of a path to an input/output device from a central processing unit, the path selecting unit identifies a virtual information processing apparatus to which the central processing unit belongs, searches the storing unit by using apparatus identification information of an identified virtual information processing apparatus and virtual device identification information included in the enquiry as a key, retrieves path identification information of an enquired path and corresponding physical device identification information, and returns retrieved path identification information and physical device identification information to the central processing unit in response to the enquiry, and
the central processing unit uses the physical device identification information returned in response to the response as the device identification information.

9. The system control device according to claim 6, wherein when plural paths are retrieved from a search of the storing unit, the path selecting unit selects one of the paths in turn and returns a selected path to the central processing unit in response to the enquiry.

10. An input/output requesting method for an information processing apparatus having redundant paths connecting a central processing unit and an input/output device, the input/output requesting method comprising:
path enquiring including a central processing unit issuing an enquiry of a path to an input/output device;
path selecting including a path selecting unit searching, upon receiving the enquiry of a path issued at the path enquiring, a storing unit that stores therein device identification information for identifying an input/output device and path identification information for identifying a path to the input/output device by using device identification information included in the enquiry as a key, retrieving path identification information of an enquired path, and returning retrieved path identification information to the central processing unit in response to the enquiry;
input/output executing including the central processing unit issuing an input/output command for a path returned in response to the enquiry; and
updating, when one of the paths becomes unavailable, the storing unit such that an unavailable path is not selected at the path selecting.

11. The input/output requesting method according to claim 10, wherein when plural paths are retrieved from a search of the storing unit, the path selecting further includes selecting one of the paths in turn and returning a selected path to the central processing unit in response to the enquiry.
